(19) United States
(12) Patent Application Publication
(10) Pub. No.: US 2023/0347839 A1
(43) Pub. Date: Nov. 2, 2023

(54) VEHICLE CONTROL SYSTEM, PROGRAM WRITING METHOD, AND VEHICLE MANUFACTURING METHOD

(71) Applicant: HONDA MOTOR CO., LTD., Tokyo (JP)

(72) Inventor: Yosuke Shionoya, Tokyo (JP)

(21) Appl. No.: 18/185,504

(22) Filed: Mar. 17, 2023

(30) Foreign Application Priority Data
Mar. 31, 2022 (JP) 2022-061006

(51) Int. Cl. B60R 16/023; G06F 8/65

(52) U.S. Cl. CPC B60R 16/0231; G06F 8/65

(57) ABSTRACT

A vehicle control system includes a vehicle control unit which includes a non-volatile program storage unit and controls a function unit installed in a vehicle by executing a program stored in the program storage unit and a master control unit which is connected with the vehicle control unit, and the master control unit includes a non-volatile master storage unit, stores writing data for writing the program to the program storage unit in the master storage unit, transmits a wake-up request to the vehicle control unit, instructs the vehicle control unit which responds to the wake-up request to make transition to a first mode as an action mode for program writing, and executes a writing process of writing the program to the program storage unit provided to the vehicle control unit, on which transition to the first mode occurs, based on the writing data.

### INCORPORATION BY REFERENCE

The present application claims priority under 35 U.S.C.§119 to Japanese Patent Application No. 2022-061006 filed on Mar. 31, 2022. The content of the application is incorporated herein by reference in its entirety.

### BACKGROUND OF THE INVENTION

### Field of the Invention

The present invention relates to a vehicle control system, a program writing method, and a vehicle manufacturing method.

### Description of the Related Art

In recent years, with sophistication of functions of vehicles, an increase in electronic control units (ECU) installed in a vehicle and sophistication of programs controlling ECUs have been progressing. For example, achievement in research and development about an improvement in fuel efficiently which contributes to higher energy efficiency has been applied to vehicles, and enhancement of functions of an ECU which controls an engine or a motor has been progressing. Further, installation of a sophisticated ECU which deals with driving assistance technologies and preventive safety technologies has been progressing. With such technological evolution, management of programs installed in an ECU has become an important problem. For example, Japanese Patent Laid-Open No. 2019-144669 discloses a method of updating an ECU which is installed in a vehicle.

### SUMMARY OF THE INVENTION

### Technical Problem

A program to be executed by an ECU is demanded to be compatible with a specification of a vehicle, and version upgrading of a program is performed with the aim of an improvement in a function and an improvement in reliability. Consequently, in a process of manufacturing a vehicle, necessity of checking a specification or a version of a program for an ECU occurs. For example, as for some ECUs, programs are written in those by a supplier manufacturing the ECUs, and the ECUs are thereafter supplied to manufacturing steps. For such ECUs, in the manufacturing steps of the vehicle, it is necessary to check compatibility between the programs and the specification of the vehicle and the versions of the programs, and the programs are updated in accordance with necessity. Consequently, there has been a problem that management of the programs of the ECUs in the manufacturing steps of the vehicle is time consuming. In view of reduction in an emission amount of carbon dioxide in manufacturing steps of the vehicle, it is desirable to shorten a time period for management of a program for an ECU and to improve manufacturing efficiency of the vehicle.

An object of the present invention, which has been made in consideration of such a background, is to shorten a work time period for management of a program for an ECU to be installed in a vehicle and to improve manufacturing efficiency of a vehicle.

### Solution to Problem

One aspect for achieving the above object provides a vehicle control system including: a vehicle control unit which includes a non-volatile program storage unit and controls a function unit installed in a vehicle by executing a program stored in the program storage unit; and a master control unit which is connected with the vehicle control unit, in which the master control unit includes a non-volatile master storage unit, stores writing data for writing the program to the program storage unit in the master storage unit, transmits a wake-up request to the vehicle control unit, instructs the vehicle control unit which responds to the wake-up request to make transition to a first mode as an action mode for program writing, and executes a writing process of writing the program to the program storage unit provided to the vehicle control unit, on which transition to the first mode occurs, based on the writing data. Advantageous Effects of Invention

In the above configuration, it is possible to write a program to a vehicle control unit by a master control unit of a vehicle control system. Accordingly, the master control unit writes the program to the vehicle control unit in manufacturing steps of a vehicle, and it thereby is possible to skip or simplify a step of checking a specification or a state of the program of the vehicle control unit and a step of writing the program to each vehicle control unit. Thus, it is possible to shorten a production time period in a manufacturing factory of the vehicle, and reduction in an emission amount of carbon dioxide in the manufacturing steps of the vehicle can be realized.

### BRIEF DESCRIPTION OF DRAWINGS

FIG. 1 is an outline configuration diagram of a vehicle control system;

FIG. 2 is an explanatory diagram of manufacturing steps of a vehicle;

FIG. 3 is a block diagram illustrating a principal component configuration of the vehicle control system;

FIG. 4 is a state transition diagram illustrating transition of a target ECU among action modes;

FIG. 5 is a flowchart illustrating actions of the vehicle control system;

FIG. 6 is a flowchart illustrating actions of the vehicle control system;

FIG. 7 is a flowchart illustrating actions of the vehicle control system;

FIG. 8 is a sequence diagram illustrating actions of the vehicle control system;

FIG. 9 is a sequence diagram illustrating actions of the vehicle control system; and

FIG. 10 is a sequence diagram illustrating actions of the vehicle control system.

### DETAILED DESCRIPTION OF THE PREFERRED EMBODIMENT

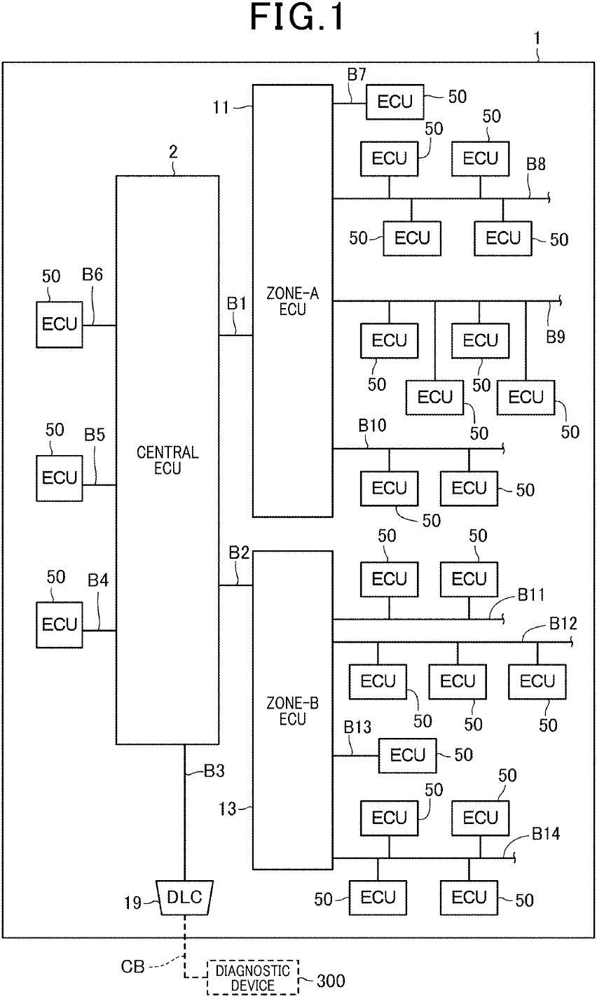

FIG. 1 is a diagram illustrating a vehicle control system 1.

The vehicle control system 1 is formed from plural ECUs 50 which control function units installed in a vehicle. The vehicle control system 1 controls the function units of the vehicle and thereby realizes travel of the vehicle and various functions.

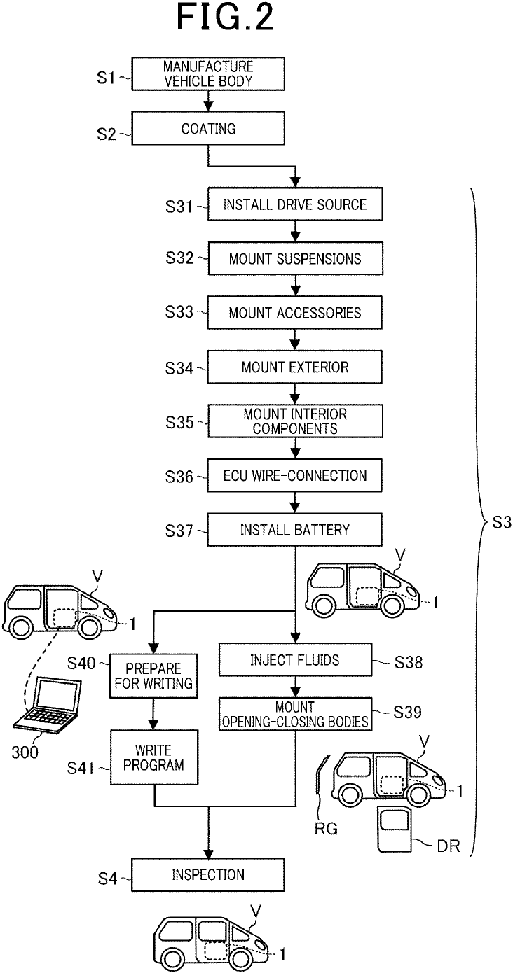

A specific form of the vehicle in which the vehicle control system 1 is installed is not limited. The vehicle may be a four-wheeled automobile or may be a motorcycle or another moving body. The vehicle may be a vehicle which uses an internal combustion engine as a drive source, may be an electric vehicle which uses a motor as a drive source, or may be a hybrid vehicle which uses an internal combustion engine and a motor. In the present embodiment, as illustrated in FIG. 2, a description will be made about a vehicle V, which is a four-wheeled automobile, as an example.

The following description explains examples of various ECUs 50 which are installed in the vehicle V and apparatuses which are controlled by the ECUs 50. It is not intended that the ECUs 50 included in the vehicle V as an application target of the present disclosure are limited to a manner of connection illustrated in FIG. 1.

The vehicle control system 1 includes a central ECU 2 which performs general control of the vehicle V and information processing. The central ECU 2 is connected with communication lines including communication wires B1 to B6. The central ECU 2 realizes a function of a gateway which manages delivery and acceptance of communication data among those communication lines. The central ECU 2 executes writing of programs to be executed by the ECUs for the ECUs which are connected with the central ECU 2 by the communication wires B1 to B6 and for the ECUs which are connected with the above ECUs by other communication wires B7 to B14. Writing of a program includes update of a program which is already written in the ECU and newly writing a program in the ECU. The central ECU 2 executes over-the-air (OTA) management, for example. The OTA management includes control about a process of downloading an update program for the ECU included in the vehicle V from a server on the outside of the vehicle and about a process of applying a downloaded update program to an in-vehicle device, for example. The central ECU 2 corresponds to one example of a master control unit in the present disclosure, and each of the ECUs to which a program is written by the central ECU 2 corresponds to one example of a vehicle control unit. The vehicle control unit includes a zone-A ECU 11, a zone-B ECU 13, and the ECUs 50 illustrated in FIG. 1, for example.

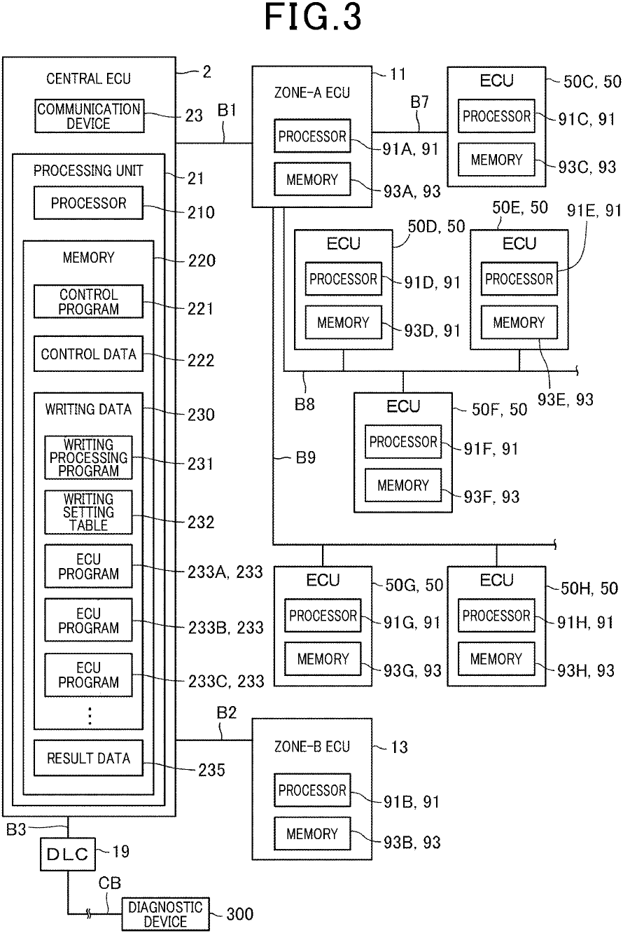

In FIG. 1 and FIG. 3 described later, each of various ECUs which are connected with the central ECU 2, the zone-A ECU 11, and the zone-B ECU 13 is denoted as ECU 50.

With the central ECU 2, the zone-A ECU 11 is connected by the communication wire B1, and the zone-B ECU 13 is connected by the communication wire B2. As described later, in addition, plural ECUs 50 are connected with the zone-A ECU 11 and the zone-B ECU 13. The zone-A ECU 11 manages delivery and acceptance of communication data between the central ECU 2 and the ECUs 50 which are connected with the zone-A ECU 11. The zone-B ECU 13 manages delivery and acceptance of communication data between the central ECU 2 and the ECUs 50 which are connected with the zone-B ECU 13.

With the central ECU 2, a data link connector (DLC) 19 is connected by the communication wire B3. The DLC 19 is an interface device which connects external devices of the vehicle V with the central ECU 2. The DLC 19 includes a connector with which a communication cable is connectable and is connected with a diagnostic device 300, for example, via the communication cable CB. The DLC 19 corresponds to one example of a connection unit in the present disclosure.

The diagnostic device 300 is a terminal device which is used by a worker in manufacturing steps of the vehicle V. The diagnostic device 300 is connected with the DLC 19 by the communication cable CB, for example. The diagnostic device 300 performs transmission and reception of various commands and data to and from the vehicle control system 1, thereby acquires information about the vehicle control system 1, and transmits an instruction to the vehicle control system 1. The diagnostic device 300 includes a processor, operation units such as keys and switches which are operated by the worker, a display unit which displays an action state of the diagnostic device 300 and information about the vehicle control system 1, a connector for connecting with the communication cable CB, and so forth. The diagnostic device 300 corresponds to one example of an external device in the present disclosure.

With the central ECU 2, plural ECUs 50 are connected by the communication wires B4, B5, and B6. Those ECUs 50 include a vehicle-to-everything (V2X) communication device, for example. The V2X communication device is a communication device that includes a communication antenna and a communication circuit, which are not illustrated, and that has a wireless communication function and performs vehicle-to-vehicle communication or road-to-vehicle communication in accordance with control by the central ECU 2. The ECUs 50 which are connected with the central ECU 2 may include a telematics control unit (TCU). The TCU is a wireless communication device that includes a communication antenna and a communication circuit, which are not illustrated, and that executes wireless data communication by a cellular communication system such as long-term evolution (LTE) or the fifth-generation mobile communication system (5G). The ECUs 50 which are connected with the central ECU 2 may include an in-vehicle infotainment (IVI) ECU. With the IVI-ECU, in-vehicle apparatuses such as an automotive navigation system, various cameras including a rear camera, an audio player, a monitor, a touch panel, operation elements such as keys and switches, a speaker, and a microphone are connected. The IVI-ECU controls the in-vehicle apparatuses and thereby provides various kinds of information and entertainment for an occupant of the vehicle V. For example, the IVI-ECU executes control such as starts and stops of the in-vehicle apparatuses, control for outputting data and so forth, which are detected by a sensor by the other ECU, and so forth.

The ECUs 50 which are connected with the central ECU 2 may include a driving assistance ECU which executes control for automatically parking the vehicle V at a parking position or an assistance function in a case where a driver parks the vehicle V. Function units as control targets of the driving assistance ECU include various cameras, a monitor, a touch panel, a steering device, a brake mechanism, and an acceleration device, which are installed in the vehicle V, for example.

The DLC 19 is one example of a function unit which is controlled by the central ECU 2. The same applies to the V2X communication device and the TCU.

With the zone-A ECU 11, plural ECUs 50 are connected by the communication wires B7 to B10. The ECUs 50 which are connected with the zone-A ECU 11 include a fuel injection (FI) control unit, a motor control unit, a battery (BATT) control unit, a shift control unit, a vehicle stability assist (VSA) control unit, and so forth, for example. The ECUs 50 which are connected with the zone-A ECU 11 by the communication wires B7 to B10 can be considered to be function units as control targets of the zone-A ECU 11.

The FI control unit controls a fuel injection amount and a fuel injection timing in an internal combustion engine which is installed in the vehicle V. Function units as control targets of the FI control unit include an electronic control fuel injection device and may include sensors. As sensors, an O2 sensor, a knock sensor, a cam angle sensor, a crank angle sensor, an intake air temperature sensor, an exhaust gas temperature sensor, and so forth can be raised. The motor control unit controls a rotation speed of a motor which is installed in the vehicle V. Function units as control targets of the motor control unit include an inverter circuit which supplies a driving current to the motor and may include various sensors. The BATT control unit performs charge control, discharge control, and management of a remaining charge amount for a traveling battery which is installed in the vehicle V. A battery as a function unit as a control target of the BATT control unit is a battery that is separately provided from a starting battery which supplies power to each unit of the vehicle control system 1 and is installed in the vehicle V for supplying a driving power source for the motor. The traveling battery may be a lithium-ion secondary battery, a lithium polymer battery, a nickel-metal hydride battery, a solid-state battery, another secondary battery, or a capacitor. Function units as control targets of the BATT control unit may include a regenerative mechanism which generates regenerative power by traveling energy of the vehicle V. Meanwhile, the starting battery of the vehicle V is a secondary battery which supplies power to each unit of the vehicle control system 1 in a state where a power source of the vehicle V is turned off and is charged by a generating device installed in the vehicle V during travel of the vehicle V. For example, the starting battery is formed from a lead-acid battery, another secondary battery, or a capacitor.

The shift control unit controls a shift mechanism of the vehicle V in accordance with a traveling state of the vehicle V and an operation by the driver. Function units as control targets of the shift control unit include the shift mechanism of the vehicle V, and specifically, a step automatic transmission (AT), a continuously variable transmission (CVT), a dual clutch transmission (DCT), or the like is raised. The function units as the control targets of the shift control unit may include a shift position sensor, a shift switch, a shift lever, and so forth.

A function unit as a control target of the VSA control unit is an actuator provided to a brake mechanism of the vehicle V, for example. The VSA control unit causes the actuator of the brake mechanism to act in accordance with a posture or the like of the vehicle V and thereby stabilizes the posture of the traveling vehicle V, and in advance prevents a slip and a spin, for example.

With the zone-B ECU 13, plural ECUs 50 are connected by the communication wires B11 to B14. The ECUs 50 which are connected with the zone-B ECU 13 includes a light control unit and an entry control unit, for example. The ECUs 50 which are connected with the zone-B ECU 13 by the communication wires B11 to B14 can be considered to be function units as control targets of the zone-B ECU 13.

Function units as control targets of the light control unit are lamp bodies which are installed in the vehicle V, that is, lighting devices. For example, the control targets of the light control unit include headlights, direction indicators, fog lamps, brake lights, and reversing lights. The light control unit may control a lamp body, which illuminates an inside of a vehicle cabin of the vehicle V, as a control target. A function unit as a control target of the entry control unit is a wireless communication device which performs wireless communication with a key with a fob or another electronic key of the vehicle V. The entry control unit executes communication with the key of the vehicle V, thereby processes user access to the vehicle control system 1 from the outside of the vehicle, and realizes an action of so-called smart entry.

The communication wires B1 to B14 are formed from plural communication transmission paths which conform to various communication standards. Each of the communication wires B1 to B14 can be provided as a data transmission path which conforms to a different communication standard. That is, a specific configuration, a transmission band, and a communication standard of a cable that constitutes each of the communication wires B1 to B14 are arbitrarily selected. As communication standards which are applicable to the communication wires B1 to B14, for example, a controller area network (CAN), Ethernet®, a universal serial bus (USB), a local interconnect network (LIN), and a low-voltage differential signaling (LVDS) can be raised, but other standards may be used. The communication wires B1 to B6 are illustrated, in FIG. 1, as independent communication lines, but their specific configurations are not restricted, and for example, the communication wires B1 to B6 may be bus communication lines, which are connected with plural apparatuses, similarly to the communication wires B7 to B14.

FIG. 2 is an explanatory diagram of the manufacturing steps of the vehicle V. FIG. 2 is a diagram which illustrates an outline of the manufacturing steps of a four-wheeled automobile while dividing the outline based on principal contents but does not limit details of the manufacturing steps of devices of the vehicle. For example, a step indicated as one step in FIG. 2 may include plural detailed steps. The order of steps which is illustrated in FIG. 2 may appropriately be switched. As for manufacturing of the vehicle V, performance of a step which is not illustrated in FIG. 2 is not excluded.

The steps illustrated in FIG. 2 indicate steps of a main manufacturing line in a manufacturing factory of the vehicle V in a simplified manner, for example. In the manufacturing steps of the vehicle V, other steps in a so-called sub-line, which is different from the main manufacturing line, may be conducted, and although other steps may be conducted in another manufacturing factory or component factory, those steps are skipped in FIG. 2.

Step S1 denotes a vehicle body manufacturing step. In the vehicle body manufacturing step, various treatments such as pressing and welding are performed for row materials such as steel and aluminum materials or for structure components which are manufactured in another factory. In step S1, a vehicle body of the vehicle V, a so-called frame is manufactured.

Step S2 denotes a coating step. In the coating step, coating for the vehicle body manufactured in step S1 is performed.

Step S3 denotes an assembling step. In the assembling step, exterior components, interior components, driving system components, and other various components are mounted on the vehicle body for which coating is performed in the coating step. Following step S3, in step S4, an inspection step is performed. In the inspection step in step S4, a completion inspection of the vehicle V is performed.

In FIG. 2, the assembling step in step S3 is more specifically illustrated.

The assembling step includes a drive source installation step (step S31), a suspension mounting step (step S32), an accessory mounting step (step S33), an exterior mounting step (step S34), an interior component mounting step (step S35), an ECU wire-connection step (step S36), and a battery installation step (step S37).

In the drive source installation step (step S31), an internal combustion engine and/or a motor as drive sources of the vehicle V are mounted on the vehicle body. In manufacturing the vehicle V having the internal combustion engine, in step S31, components of an intake system and an exhaust system which are connected with the internal combustion engine are mounted. In manufacturing the vehicle V in which the motor is installed, in step S31, the traveling battery is mounted. In step S31, a transmission may be mounted together with the drive source. In step S31, a part or all of the ECUs 50 to be connected with the drive source are installed in the vehicle body. For example, in step S31, the ECUs 50 such as the FI control unit, the motor control unit, the BATT control unit, and the shift control unit may be installed in the vehicle body.

In the suspension mounting step (step S32), a suspension mechanism which is assembled in a sub-line is mounted on the vehicle body.

In the accessory mounting step (step S33), accessories of the vehicle V are mounted. The accessories include a compressor, a condenser, refrigerant piping, an alternator, a cooling water pump, a cooling water tank, cooling water piping, and an electric oil pump, which constitute an air-conditioning device, for example, and may include other components. In the accessory mounting step, installation, connection, and so forth of brake fluid piping may be performed.

In the suspension mounting step and the accessory mounting step, a part or all of the ECUs 50 to be connected with suspensions and accessories are installed in the vehicle body. In the suspension mounting step and the accessory mounting step, the ECU 50 such as the VSA control unit may be installed in the vehicle body.

In the exterior mounting step (step S34), exterior components such as bumpers, glass other than door glass, wipers, and lamp bodies are mounted. In the interior component mounting step (step S35), interior components of the vehicle V are mounted. The interior components include seats and a center console. In the interior component mounting step, a monitor or a touch panel of an automotive navigation system, a meter panel, and various cameras are mounted on the vehicle body.

In the exterior mounting step and the interior component mounting step, a part or all of the ECUs 50 to be connected with the exterior components and so forth are installed in the vehicle body. For example, in the exterior mounting step or the interior component mounting step, the ECUs 50 such as the light control unit and the entry control unit may be installed in the vehicle body.

In the ECU wire-connection step (step S36), the central ECU 2, the zone-A ECU 11, and the zone-B ECU 13 are installed in the vehicle body. In addition, in the ECU wire-connection step, the ECUs 50, which are not installed in steps S31 to S35, among the ECUs 50 which constitute the vehicle control system 1 are installed in the vehicle body. In the ECU wire-connection step, wire-connection of the communication wires B1 to B6 is made with the central ECU 2. For example, wire-connection of the communication wires B1 to B6 is made with one or plural connectors, and in the ECU wire-connection step, the connectors are connected with the central ECU 2. In addition, in the ECU wire-connection step, the communication wires B7 to B10 are connected with the zone-A ECU 11, and the communication wires B11 to B14 are connected with the zone-B ECU 13. By the ECU wire-connection step, the central ECU 2, the zone-A ECU 11, and the zone-B ECU 13 are mutually connected with the apparatuses as the control targets and the ECUs 50, and a state is established where control by the central ECU 2 is possible. That is, all of the ECUs 50 which have to be directly connected with the central ECU 2 and the ECUs 50 which have to be connected with the central ECU 2 via the zone-A ECU 11 and the zone-B ECU 13 are connected in the ECU wire-connection step. In the ECU wire-connection step, in a state where the vehicle control system 1 is not energized, a connection test may be performed which is for checking electrical connection states between the central ECU 2 and the various ECUs 50 which are connected with the central ECU 2.

By a wire-connection step of the ECU wire-connection step, the central ECU 2, the zone-A ECU 11, and the zone-B ECU 13 are mutually connected with the apparatuses as the control targets and the ECUs 50, and a state is established where control by the central ECU 2 is possible.

The ECU wire-connection step in step S36 corresponds to one example of a wire-connection step in the present disclosure. Because the central ECU 2 and the ECUs 50 are installed in steps S31 to S36, those steps correspond to one example of a providing step in the present disclosure.

After the ECU wire-connection step (step S36), in the battery installation step (step S37), the starting battery is installed in the vehicle V. Wire-connection of the starting battery is made with the vehicle control system 1 in the ECU wire-connection step. As described above, the starting battery supplies power to the vehicle control system 1. Power of the starting battery is supplied as a power source for at least the central ECU 2, the zone-A ECU 11, and the zone-B ECU 13. After step S37, the vehicle control system 1 is started by power supplied by the starting battery and is set to a state where each unit of the vehicle control system 1 is capable of executing control. Specifically, after the step S37, the diagnostic device 300 is connected with the DLC 19, and the diagnostic device 300 is thereby capable of executing communication with the central ECU 2.

After the battery installation step (step S37), a fluid injection step (step S38) and an opening-closing body mounting step (step S39) are performed for the vehicle V. In step S38, various liquids used for the vehicle V are injected. For example, in step S38, cooling water is injected into a water-cooling mechanism which cools the drive source of the vehicle V. A brake fluid is injected into brake piping of the vehicle V. In the fluid injection step, other liquids may be injected.

In step S38, opening-closing bodies of the vehicle V are mounted. As the opening-closing bodies, for example, doors DR and a rear gate RG are raised. In step S38, the assembling step (step S3) is completed, and the inspection step in step S4 is executed.

Step S37 corresponds to one example of an injection step in the present disclosure, and step S38 corresponds to one example of an opening-closing body mounting step in the present disclosure.

In the manufacturing steps of the vehicle V of the present disclosure, in parallel with steps S38 and S39, a program writing preparation step (step S40) and a program writing step (step S41) are executed. Step S41 corresponds to one example of a writing step in the present disclosure.

The program writing preparation step is started after the battery installation step (step S37) and before the fluid injection step (step S38) or after the fluid injection step. The program writing preparation step may be finished before the opening-closing body mounting step (step S39) is started or may be continued to be executed after the opening-closing body mounting step (step S39) is started.

In the program writing step, the central ECU 2 writes programs to the ECUs 50 included in the vehicle control system 1. Targets of the program writing step include the ECUs 50 which are connected with the central ECU 2 by the communication wires B4 to B6, the ECUs 50 which are connected with the zone-A ECU 11 by the communication wires B7 to B10, and the ECUs 50 which are connected with the zone-B ECU 13 by the communication wires B11 to B14. In the program writing step, programs may be written to the zone-A ECU 2 and the zone-B ECU 13.

In the program writing preparation step, the ECU 50 as a target to which the central ECU 2 writes a program is caused to be in an action mode corresponding to writing of the program. The central ECU 2 executes the program writing step for the ECU 50, on which transition of action mode normally occurs, in the program writing preparation step.

FIG. 3 is a block diagram illustrating a principal component configuration of the vehicle control system 1.

For explaining writing of programs in the vehicle control system 1, a configuration of a part of the ECUs 50 which constitute the vehicle control system 1 is illustrated in FIG. 3.

As illustrated in FIG. 3, the central ECU 2 has a processing unit 21 and a communication device 23. The communication device 23 executes communication via the communication wires B1 to B6 in accordance with control by the processing unit 21.

The processing unit 21 includes a processor 210 and a memory 220.

The processor 210 is formed from a central processing unit (CPU), a micro-controller unit (MCU), or a micro-processor unit (MPU), for example. The memory 220 is a rewritable non-volatile storage device and stores programs which are executed by the processor 210 and data which are processed by the processor 210. The memory 220 is formed from a semiconductor storage device such as a flash read-only memory (ROM) or a solid state disk (SSD) or a magnetic storage device, for example. The memory 220 may include a random access memory (RAM) which forms a work area for temporarily storing programs and data. The processing unit 21 may be formed from an integrated circuit (IC) which integrally includes the processor 210 and the memory 220. The central ECU 2 may be an integrated circuit in which the processing unit 21 and the communication device 23 are united. The central ECU 2 may be configured to include the communication device 23, the processor 210, and the memory 220 as pieces of independent hardware.

The memory 220 stores a control program 221, control data 222, writing data 230, and result data 235.

The control program 221 is a program which is executed by the processor 210. The control data 222 are data which are referred to in a case where the processor 210 executes the control program 221. The processor 210 executes the control program 221 based on the control data 222 and thereby executes management and control of delivery and acceptance of data in the vehicle control system 1 and communication by the DLC 19. The processor 210 executes the control program 221 and thereby controls the TCU, the meter panel, and so forth. The processor 210 executes the control program 221 and thereby controls the OTA management of the ECUs 50 which constitute the vehicle control system 1. The memory 220 corresponds to one example of a master storage unit in the present disclosure.

A configuration of the ECU 50 as a writing target will be described. FIG. 3 illustrates the zone-A ECU 11, the zone-B ECU 13, and ECUs 50C, 50D, 50E, 50F, 50G, and 50H as examples of the ECUs 50 as the writing targets of the central ECU 2. The ECUs 50C to 50H are examples of the ECUs 50. Specifically, those are the FI control unit, the motor control unit, the BATT control unit, the shift control unit, the VSA control unit, and so forth. Although FIG. 3 illustrates a configuration of a part of the vehicle control system 1, a configuration may be made such that the central ECU 2 is capable of writing programs to all of the ECUs 50 included in the vehicle control system 1.

The zone-A ECU 11 includes a processor 91A and a memory 93A. The zone-B ECU 13 includes a processor 91B and a memory 93B. Similarly, the ECU 50C includes a processor 91C and a memory 93C, the ECU 50D includes a processor 91D and a memory 93D, and the ECU 50E includes a processor 91E and a memory 93E. The ECU 50F includes a processor 91F and a memory 93F, the ECU 50G includes a processor 91G and a memory 93G, and the ECU 50H includes a processor 91H and a memory 93H. In the following, in a case where the ECUs 50C to 50H are not distinguished, those are denoted as ECU 50. In a case where the processors 91A to 91H are not distinguished, those are denoted as processor 91. In a case where the memories 93A to 93H are not distinguished, those are denoted as memory 93. The memory 93 corresponds to one example of a program storage unit in the present disclosure.

The processor 91 is formed from a CPU, an MCU, or an MPU, for example. The memory 93 is a rewritable non-volatile storage device and stores programs which are executed by the processor 91 and data which are processed by the processor 91. The memory 93 is formed from a semiconductor storage device such as a flash ROM or an SSD or a magnetic storage device, for example. The memory 93 may include a RAM which forms a work area for temporarily storing programs and data. Each of the ECUs 50 may be formed from an integrated circuit which integrally includes the processor 91 and the memory 93.

The processor 91 executes a basic control program stored in the memory 93 and thereby executes communication with the central ECU 2. The processor 91 executes a control program stored in the memory 93 and thereby controls a function unit as a control target.

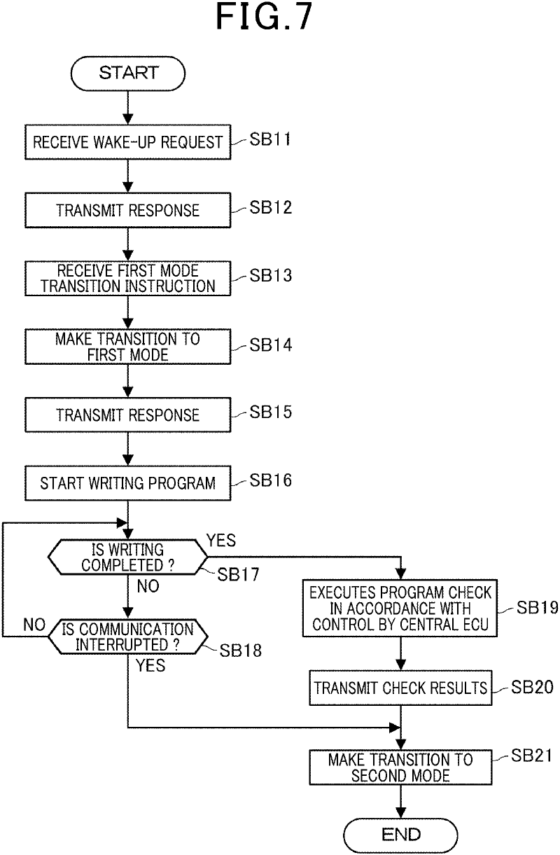

Before the program is written by the central ECU 2 in the program writing step, the memory 93 does not store the program for controlling the function unit as the control target by the processor 91. In this state, the memory 93 stores a program for executing a basic action by the processor 91. For example, before a writing process, the memory 93 stores a program, by which the processor 91 executes communication with the central ECU 2 and executes a process illustrated in FIG. 7. For example, before the program writing step, the memory 93 may already store the program for controlling the function unit as the control target by the processor 91. In this case, in the program writing step, a part of the program stored in the memory 93 is overwritten and updated.

The zone-A ECU 11 may include a communication device which executes communication by the communication wires B7 to B10 in addition to the processor 91A and the memory 93A. The zone-B ECU 13 may include a communication device which executes communication by the communication wires B11 to B14 in addition to the processor 91B and the memory 93B. Each of the ECUs 50 other than the zone-A ECU 11 and the zone-B ECU 13 may be configured to include a communication device which is not illustrated and performs data communication with the zone-A ECU 11 or the zone-B ECU 13 and performs transmission and reception of a signal to and from the function unit as the control target.

The writing data 230 which are stored in the memory 220 by the central ECU 2 are data for writing programs to the ECUs 50 of the vehicle control system 1 by the processor 210. The writing data 230 include a writing processing program 231, a writing setting table 232, and an ECU program 233.

The writing processing program 231 is a program which is executed by the processor 210. The processor 210 executes the writing processing program 231 and thereby executes writing of a program to the ECU 50 in the manufacturing steps of the vehicle V.

The writing setting table 232 includes information about the ECUs 50 as targets to which programs are written by the central ECU 2. The writing setting table 232 associates the ECU 50 as the target of the writing process to be executed by the central ECU 2 with the ECU program 233 to be written to the memory 93 provided to the ECU 50. The writing setting table 232 corresponds to one example of association data.

The writing setting table 232 includes a model number of the ECU 50 as information about the ECU 50 as the target to which the program is written by the central ECU 2. The writing setting table 232 may include information which indicates a specification and a destination of the ECU 50 in addition to the model number of the ECU 50. The writing setting table 232 may include a manufacturing number (serial number) specific to the ECU 50 or a manufacturing lot number of the ECU 50 together with the model number of the ECU 50.

The writing data 230 include plural ECU programs 233 which correspond to the respective ECUs 50 as writing targets. For example, an ECU program 233A is a program which corresponds to the zone-A ECU 11 and is written to the memory 93A. An ECU program 233B is a program which corresponds to the zone-B ECU 13 and is written to the memory 93B. An ECU program 233C is a program which corresponds to the FI control unit and is written to the memory 93C. Information which associates the ECU programs 233A, 233B, and 233C with the zone-A ECU 11, the zone-B ECU 13, and the ECU 50 is included in the writing setting table 232.

The number of ECU programs 233 included in the writing data 230 is not restricted. The writing data 230 preferably include the ECU programs 233 which correspond to all of the ECUs 50 of the vehicle control system 1 of the vehicle V in which the central ECU 2 is installed.

The ECU program 233 may be the same as a program which is written to the memory 93. The ECU program 233 may be stored in the memory 220 in a compressed state and be written to the memory 93 while being expanded by the processor 210.

The ECU as a target to which a program is written by the central ECU 2 is set as a target ECU 51. The target ECU 51 may be any ECU other than the central ECU 2 among the ECUs included in the vehicle control system 1. For example, the zone-A ECU 11, the zone-B ECU 13, the IVI-ECU, and so forth can be the target ECUs 51. The FI control unit, the motor control unit, the BATT control unit, the shift control unit, and the VSA control unit, which are connected with the zone-A ECU 11, can also be the target ECUs 51. The light control unit and the entry control unit, which are connected with the zone-B ECU 13, can also be the target ECUs 51. In the following description, a description will be made about an example where the central ECU 2 selects one or plural ECUs 50 from plural ECUs 50 included in the vehicle control system 1 and writes programs to the selected ECUs 50. The central ECU 2 is capable of writing programs simultaneously or in parallel for plural ECUs 50 and is also capable of writing programs to the ECUs 50 one by one.

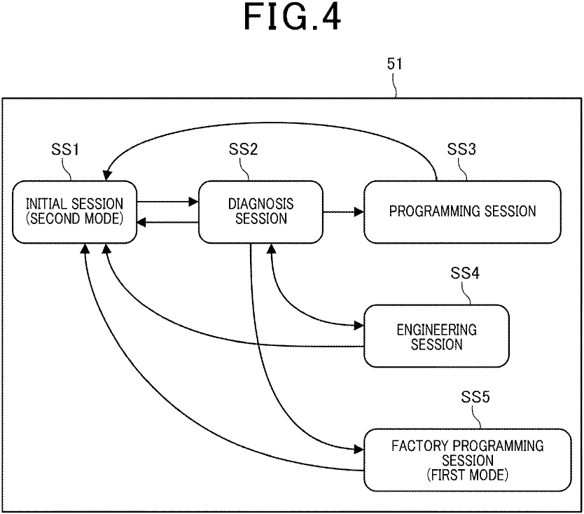

FIG. 4 is a state transition diagram illustrating transition of the target ECU 51 among action modes. The target ECU 51 illustrated in FIG. 4 may be any of the above-described ECUs 50.

As illustrated in FIG. 4, the ECU for which the central ECU 2 is capable of writing a program to the memory 93 transits among plural sessions. Here, a session indicates an action which is executed by the target ECU 51 and can be rephrased as an action mode of the target ECU 51.

The target ECU 51 executes five sessions of an initial session SS1, a diagnosis session SS2, a programming session SS3, an engineering session SS4, and a factory programming session SS5 while switching those. In the present embodiment, for convenience, the initial session SS1 will be referred to as second mode, and the factory programming session SS5 will be referred to as first mode.

The initial session SS1 corresponds to an initial state of the target ECU 51 and is a default action mode. In the initial session SS1, the target ECU 51 receives information which is input from the central ECU 2 and starts an action based on the received information.

The diagnosis session SS2 is an action mode in which a function unit as a control target of the target ECU 51 is caused to act for a diagnostic purpose, for example. For example, in a case where the target ECU 51 is the ECU 50 which performs steering control, in the diagnosis session SS2, the target ECU 51 causes an electric power steering mechanism as the function unit as the control target to act in accordance with a signal which is input from the diagnostic device 300 or the central ECU 2 and performs detection or setting of a midpoint position of steering.

The programming session SS3 is an action mode for rewriting a program which is stored in the memory 93 of the target ECU 51. The programming session SS3 is used in a case where the program stored in the memory 93 is updated or repaired after the vehicle V is shipped from a factory.

The engineering session SS4 is an action mode in which the function unit as the control target of the target ECU 51 is caused to act. The engineering session SS4 is mainly used in the manufacturing steps of the vehicle V. For example, in a case where the target ECU 51 receives a control signal transmitted by a dedicated diagnostic device 300 which is used in the manufacturing steps of the vehicle V, the target ECU 51 makes transition to the engineering session SS4 and causes the function unit as the control target to act. For example, in a case where the target ECU 51 is the VSA control unit, in the engineering session SS4, the target ECU 51 can forcibly cause the actuator provided to the brake mechanism to act. For example, in a case where the brake fluid is injected in the fluid injection step, the target ECU 51 drives the actuator in accordance with a control signal which is input from the central ECU 2.

The factory programming session SS5 is an action mode for rewriting a program which is stored in the memory 93 of the target ECU 51. Differently from the programming session SS3, the factory programming session SS5 is the action mode which is used in the manufacturing steps of the vehicle V. The factory programming session SS5 is different compared to the programming session SS3 in restriction of the number of target ECUs 51 for which writing is simultaneously performed, procedures required for writing of a program, and so forth. In the present embodiment, in a case where the central ECU 2 performs the writing process of a program in the memory 93, the factory programming session SS5 of the target ECU 51 is used.

Information which is received from the central ECU 2 by the target ECU 51 in the initial session SS1 is a wake-up request, a first mode transition instruction, and a control signal, for example. The wake-up request is information to inquire of the target ECU 51 in a standby state whether or not the target ECU 51 is in a state where a process is capable of being executed. In a case where the wake-up request is received in the initial session SS1, the target ECU 51 transmits a response to the wake-up request to the central ECU 2 and stands by until the next information is received.

The first mode transition instruction is an instruction to cause the target ECU 51 to make transition to the factory programming session SS5. In a case where the first mode transition instruction is received, the target ECU 51 makes transition of the action mode of the target ECU 51 to the factory programming session SS5 and stands by until the next information is received.

The control signal instructs the target ECU 51 to control the function unit as the control target of the target ECU 51. In a case where the control signal is received, the target ECU 51 makes transition of the action mode of the target ECU 51 to the engineering session SS4. The target ECU 51 causes the function unit as the control target to act in accordance with contents which are designated by the control signal. The target ECU 51 transmits action data, which indicate results of the action of the function unit as the control target, to the central ECU 2. For example, in a case where the VSA control unit is the target ECU 51, the control signal instructs the VSA control unit to forcibly drive the actuator in the engineering session SS4. In this case, the VSA control unit outputs the action data about an action of the actuator.

In addition to the initial session SS1, the target ECU 51 may also be capable of transmitting a response to the wake-up request in the diagnosis session SS2, the programming session SS3, the engineering session SS4, and the factory programming session SS5. In the present embodiment, this example will be described.

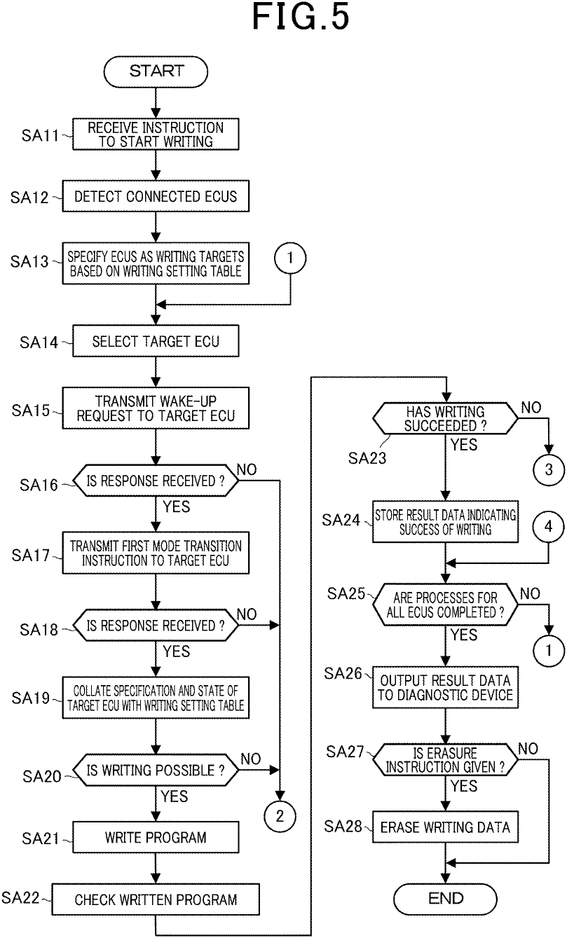

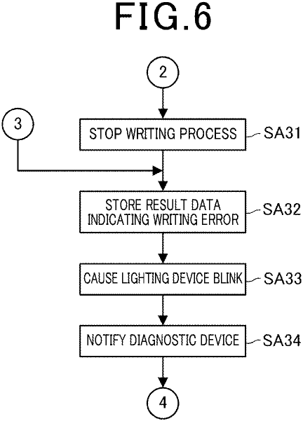

FIG. 5, FIG. 6, and FIG. 7 are flowcharts illustrating actions of the vehicle control system 1. FIG. 5 and FIG. 6 illustrate actions of the central ECU 2, and FIG. 7 illustrates actions of the target ECU 51. FIG. 5, FIG. 6, and FIG. 7 illustrate actions in the writing preparation step (step S40) and the program writing step (step S41) in the manufacturing steps of the vehicle V.

The actions illustrated in FIG. 5 and FIG. 7 are executed in a state where the diagnostic device 300 is connected with the DLC 19. Specifically, the worker operates the diagnostic device 300, and the diagnostic device 300 thereby transmits a command for instructing a start of the writing process to the vehicle control system 1. This command serves as a trigger for a start of the writing preparation step and the writing process.

The processor 210 receives the command from the diagnostic device 300 (step SA11) and detects the ECUs 50 which are connected with the central ECU 2 (step SA12). In step SA12, the processor 210 detects the ECUs 50 which are connected with the central ECU 2 by the communication wires B1 to B6 and further the ECUs 50 which are connected with the central ECU 2 via the zone-A ECU 11 and the zone-B ECU 13.

The processor 210 specifies the ECUs 50 set as targets of the writing process based on the writing setting table 232 (step SA13). The processor 210 can execute writing of programs to plural ECUs 50 by using the writing data 230. In step SA13, among the ECUs 50 detected in step SA12, all of the ECUs 50 are specified which can be the targets of the writing process.

The processor 210 selects one or plural target ECUs 51 from the ECUs 50 specified in step SA13 (step SA14). In a case where plural target ECUs 51 are selected, the processor 210 may execute actions indicated by steps SA15 to SA25 and SA31 to SA34, which will be described in the following, for one target ECU 51 and may execute those processes in parallel or sequentially for the number of target ECUs 51.

The processor 210 transmits the wake-up request to the target ECU 51 (step SA15). The wake-up request is a signal to request the target ECU 51 in the standby state to start. The target ECU 51 is capable of receiving the wake-up request in a state where the power source is supplied by the starting battery. In a normal action, the target ECU 51 transmits a response to the wake-up request to the central ECU 2 as described later.

The processor 210 determines whether or not the response to the wake-up request is received from the target ECU 51 (step SA16). In a case where the response is not received in a predetermined time period (NO in step SA16), the processor 210 proceeds to step SA31 which will be described later.

In a case where the response is received from the target ECU 51 (YES in step SA16), the processor 210 transmits the first mode transition instruction to the target ECU 51 (step SA17). The processor 210 determines whether or not a response to the first mode transition instruction is received from the target ECU 51 (step SA18). In a case where the response is not received in a predetermined time period (NO in step SA18), the processor 210 proceeds to step SA31 which will be described later.

For example, steps SA11 to SA18 correspond to the writing preparation step. For example, steps SA19 to SA34 correspond to the writing step.

In a case where the response is received from the target ECU 51 (YES in step SA18), the processor 210 collates at least either one of a specification and a state of the target ECU 51 with the writing setting table 232 (step SA19). The specification of the target ECU 51 indicates a model number of the target ECU 51, a destination of the target ECU 51, and a specification adapted to attached components of the vehicle V. The state of the target ECU 51 means presence or absence of a program which is already stored in the memory 93 of the target ECU 51, a version of a program, and so forth. The writing setting table 232 includes information which designates the specification and/or the state of the target ECU 51, to which the ECU program 233 is capable of being written, for each of the ECUs 50 which can be the target ECUs 51. The processor 210 causes the target ECU 51 to transmit information which indicates the specification and the state for collation in step SA19.

The processor 210 determines whether or not writing of a program to the target ECU 51 is possible as a result of the collation in step SA19 (step SA20). In a case where it is determined that writing is not possible (NO in step SA20), the processor 210 proceeds to step SA31 which will be described later.

In a case where it is determined that writing is possible (YES in step SA20), the processor 210 writes the program to the memory 93 provided to the target ECU 51 (step SA21). The program which is written by the processor 210 in step SA21 is the ECU program 233 which is associated with the target ECU 51 by the writing setting table 232.

The processor 210 checks the program which is written to the memory 93 by a process in step SA19 (step SA22). In step SA22, the processor 210 may instruct the target ECU 51 to check the program, and the target ECU 51 may thereby execute a check. The processor 210 may read out the program written to the memory 93 and thereby execute the check.

The processor 210 determines whether or not writing of the program is normally completed based on results of the check in step SA22 (step SA23).

In a case where it is determined that writing of the program is not normally completed (NO in step SA23), the processor 210 proceeds to step SA32 which will be described later.

In a case where it is determined that writing of the program is normally completed (YES in step SA23), the processor 210 generates result data 235 which indicate success of writing and stores the result data 235 in the memory 220 (step SA24). The result data 235 are data including information which indicates the target ECU 51 and information which indicates that writing has succeeded.

The processor 210 determines whether or not processes for all of the ECUs 50 specified in step SA13 are completed (step SA25). In other words, the processor 210 determines whether or not all of the ECUs 50 are selected as the target ECUs 51 in step SA14. In a case where it is determined that the processes for all of the ECUs 50 are completed (YES in step SA25), the processor 210 outputs the result data 235 stored in the memory 220 to the diagnostic device 300 via the DLC 19 (step SA26).

The processor 210 determines whether or not an instruction to erase the writing data 230 is input from the diagnostic device 300 (step SA27). In a case where the instruction for erasure is input (YES in step SA27), the processor 210 erases the writing data 230 from the memory 220 (step SA28) and finishes the current process. In a case where the instruction for erasure is not input (NO in step SA27), the processor 210 skips step SA28 and finishes the current process.

In a case where it is determined that the ECU 50 for which the process is not completed is present (NO in step SA25), the processor 210 returns to step SA14 and selects the next target ECU 51.

Meanwhile, in step SA31, the processor 210 stops the process for the target ECU 51 which has been selected (step SA31). Next, in step SA32, the processor 210 generates the result data 235 which indicate a writing error and stores the result data 235 in the memory 220 (step SA32). The result data 235 which are generated in step SA32 include information that indicates the target ECU 51 which has been selected and information that indicates that writing has not succeeded. The result data 235 correspond to one example of writing error information.

The processor 210 further causes the lamp body installed in the vehicle V to blink (step SA33). In step SA33, for example, the processor 210 controls the light control unit which controls the lamp body and thereby causes the direction indicator of the vehicle V to blink. Accordingly, an occurrence of an error to writing of the program can be notified to the worker who is present along a manufacturing line of the vehicle V. In addition, the processor 210 notifies the occurrence of the error to writing of the program to the diagnostic device 300 via the DLC 19 (step SA34) and proceeds to step SA23. In step SA34, the processor 210 may transmit a signal, which indicates the occurrence of the error to writing of the program, to the diagnostic device 300. Alternatively, the processor 210 may transmit the result data 235 to the diagnostic device 300. In this case, an advantage can be obtained where the diagnostic device 300 displays contents of the result data 235 and the worker can thereby be informed of contents of the error in detail.

As illustrated in FIG. 7, the processor 91 of the target ECU 51 receives the wake-up request from the central ECU 2 (step SB11). The target ECU 51 can receive the wake-up request in a state where the power source is supplied by the starting battery. That is, the target ECU 51 receives the wake-up request in all of the action modes illustrated in FIG. 4 and transmits the response to the wake-up request. After receiving the wake-up request, the processor 91 may execute initialization of each unit including the memory 93, transition among the action modes for writing the program, and so forth.

The processor 91 transmits the response to the wake-up request to the central ECU 2 (step SB12).

As described above, the central ECU 2 receives the response to the wake-up request and thereafter transmits the first mode transition instruction. The processor 91 receives the first mode transition instruction (step SB13) and makes transition to the first mode, that is, the factory programming session SS5 (step SB14). The processor 91 transmits a response, which notifies that the processor 91 makes transition to the factory programming session SS5, to the central ECU 2 (step SB15).

Subsequently, the processor 91 starts writing of the program to the memory 93 in accordance with control by the central ECU 2 (step SB16). After writing of the program is started, the processor 91 periodically determines whether or not writing is completed (step SB17). In a case where it is determined that writing is not completed (NO in step SB17), the processor 91 determines whether or not communication with the central ECU 2 is interrupted (step SB18). Interruption of communication with the central ECU 2 indicates that a state where the target ECU 51 does not receive a signal or data from the central ECU 2 continues for a predetermined time period, which is in advance set, or more. In a case where it is determined that communication is not interrupted (NO in step SB18), the processor 91 returns to step SB16. In a case where it is determined that communication is interrupted (YES in step SB18), the processor 91 proceeds to step SB21 which will be described later.

In a case where it is determined that writing of the program is completed (YES in step SB17), the processor 91 executes a check of the program which is written to the memory 93 in accordance with control by the central ECU 2 (step SB19). The processor 91 transmits check results to the central ECU 2 (step SB20) and proceeds to step SB21. Note that as described above, in a case where the central ECU 2 executes the check of the program which is written to the memory 93, step SB19 is skipped.

In step SB21, the processor 91 causes the action mode of the target ECU 51 to make transition to the second mode, that is, the initial session SS1 (step SB21) and finishes the current process.

The actions illustrated in FIG. 5 to FIG. 7 are executed while at least a part of the ECUs 50 of the vehicle control system 1 installed in the vehicle V are set as the target ECUs 51, and work for checking specifications and states of programs of the ECUs 50 in the manufacturing steps of the vehicle V can thereby be reduced. In addition, when programs are written to a larger number of ECUs 50 by the actions illustrated in FIG. 5 to FIG. 7, much higher efficiency of the manufacturing steps of the vehicle V can be intended.

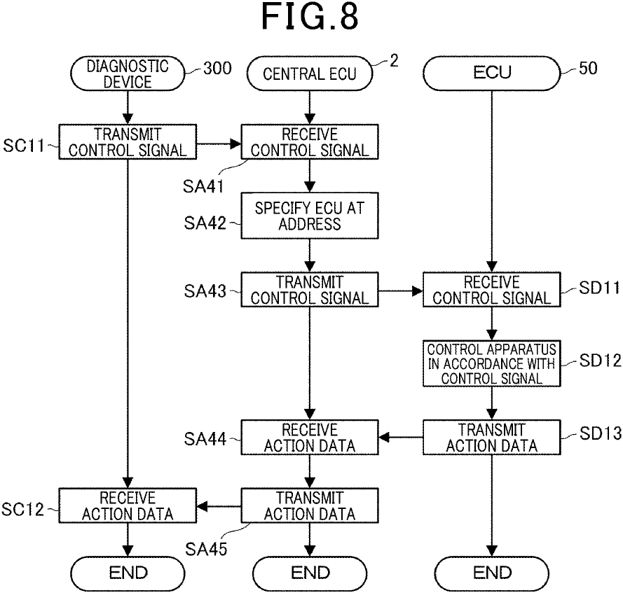

FIG. 8 is a sequence diagram illustrating actions of the vehicle control system 1 and illustrates actions in a case where the diagnostic device 300 transmits a control signal to the central ECU 2. The central ECU 2 executes steps SA41 to SA45 in FIG. 8, and the diagnostic device 300 executes actions in steps SC11 and SC12. Steps SD11 to SD13 are processes which are executed by any of the ECUs 50 included in the vehicle control system 1. For example, the VSA control unit executes steps SD11 to SD13.

The actions in FIG. 8 are actions in a case where the diagnostic device 300 transmits the control signal while the ECU 50 is executing the initial session SS1. The ECU 50 may be configured to be capable of executing the actions in FIG. 8 while the ECU 50 is executing the diagnosis session SS2 and also while the ECU 50 is executing the engineering session SS4.

In a case where the target ECU 51 is caused to execute the action, the diagnostic device 300 transmits the control signal to the central ECU 2 (step SC11). For example, in the fluid injection step which is executed in parallel with the writing preparation step, in order to cause the actuator of the brake mechanism to act when the brake fluid is injected, the worker operates the diagnostic device 300 to cause that to transmit the control signal.

The processor 210 receives the control signal which is transmitted by the diagnostic device 300 (step SA41) and specifies the ECU 50 at an address of the control signal (step SA42). The processor 210 transfers the control signal to the target ECU 50 at the address (step SA43).

The ECU 50 receives the control signal from the central ECU 2 (step SD11), controls the function unit as the control target in accordance with the control signal (step SD12), generates action data which indicate results of the control, and transmits the action data to the central ECU 2 (step SD13). For example, the VSA control unit forcibly causes the actuator of the brake mechanism to act in step SD12, generates action data which indicate results of the action of the actuator, and transmits the action data to the central ECU 2 in step SD13.

The processor 210 receives the action data which are transmitted by the ECU 50 (step SA45) and transmits the received action data to the diagnostic device 300 (step SA46). The diagnostic device 300 receives the action data (step SC12). The diagnostic device 300 may display contents of the received action data such that the worker can visually recognize those.

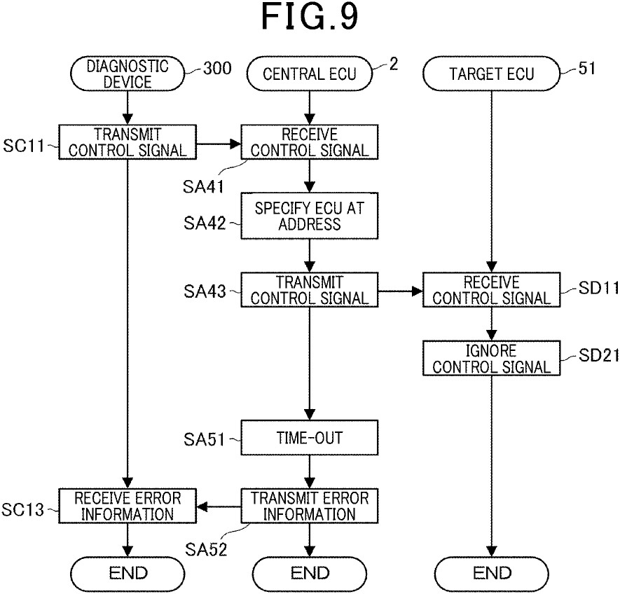

FIG. 9 illustrates actions in a case where the diagnostic device 300 transmits the control signal to the ECU 50 for which a process for writing the program is performed by the central ECU 2. The central ECU 2 executes steps SA41 to SA43, SA51, and SA52 in FIG. 9, and the diagnostic device 300 executes actions in steps SC11 and SC13. Steps SD11 and SD21 are processes which are executed by the ECU 50 for which writing of the program is performed in the vehicle control system 1, that is, the target ECU 51. For example, the VSA control unit executes steps SD11 and SD21. In FIG. 9, the same step numbers as FIG. 8 are given to the actions shared by FIG. 8, and descriptions thereof will not be made.

FIG. 9 illustrates the actions performed while the target ECU 51 is executing the factory programming session SS5. In a case where the control signal transmitted by the central ECU 2 is received (step SD11), the target ECU 51 ignores this control signal (step SD12) and does not respond to the control signal.

In this case, in accordance with the fact that no response is made from the target ECU 51 for a predetermined time period or more after the control signal is transmitted to the target ECU 51, the processor 210 determines that a time-out has occurred (step SA51). The processor 210 transmits error information to the diagnostic device 300 (step SA52).

The diagnostic device 300 receives the error information from the central ECU 2 (step SC13). The diagnostic device 300 may display contents of the received error information such that the worker can visually recognize those.

As described above, the target ECU 51 does not execute the action following the control signal in the factory programming session SS5. Thus, the function unit as the control target is not controlled in writing of the program. Consequently, a disturbance can be prevented from occurring to writing of the program due to access by the processor 91 of the target ECU 51 to the memory 93 in writing, and writing of the program can more certainly be completed.

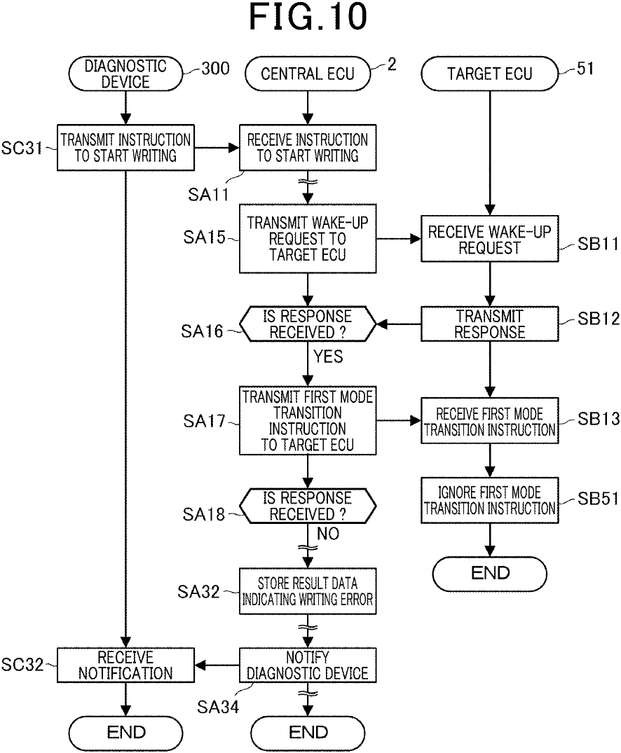

FIG. 10 illustrates actions in a case where the target ECU 51 which is selected by the central ECU 2 in step SA14 controls the function unit as the control target based on the control signal which is transmitted by the diagnostic device 300. That is, those are actions in a case where the central ECU 2 attempts to perform writing to the target ECU 51 while the target ECU 51 is executing the engineering session SS4.

The central ECU 2 executes steps SA41 to SA43, SA51, and SA52 in FIG. 10, and the diagnostic device 300 executes actions in steps SC31 and SC32. Steps SA11, SA15 to SA18, SA32, and SA34 indicate actions of the central ECU 2, and a part of the actions are shared by FIG. 5 and FIG. 6. Steps SB11 to SB13 and SB51 indicate actions of the target ECU 51, and a part of the actions are shared by FIG. 7. In FIG. 10, the same step numbers are given to the actions shared by FIG. 5 to FIG. 7, and descriptions thereof will not be made.

When the diagnostic device 300 transmits an instruction to start writing to the central ECU 2 (step SC31), the processor 210 receives the instruction to start writing (step SA11) and starts the actions in FIG. 5. The processor 210 selects the target ECU 51 and thereafter transmits the wake-up request to the target ECU 51 (step SA15).

Here, in a case where the wake-up request is received (step SB11), the target ECU 51 which is executing the engineering session SS4 transmits the response to the wake-up request to the central ECU 2 (step SB12).

In a case where the response to the wake-up request is received from the target ECU 51, the processor 210 determines that the response is made (YES in step SA16) and transmits the first mode transition instruction to the target ECU 51 (step SA17).

When the first mode transition instruction is received from the central ECU 2 (step SB13), because the target ECU 51 is executing the engineering session SS4, the target ECU 51 ignores the first mode transition instruction (step SB51). Unless the target ECU 51 once makes transition to the initial session SS1 in the engineering session SS4, the target ECU 51 does not make transition to the factory programming session SS5. In other words, during execution of control based on the control signal of the diagnostic device 300 in the engineering session SS4, unless this control is completed, the target ECU 51 does not make transition to the first mode.

Based on the fact that no response is made for a predetermined time period or more after the first mode transition instruction is transmitted to the target ECU 51, the processor 210 determines that no response is made (NO in step SA18). In this case, the processor 210 generates result data which indicate the writing error and stores the result data in the memory 220 (step SA32). The processor 210 notifies the writing error to the diagnostic device 300 (step S34), and the diagnostic device 300 receives a notification about the writing error from the central ECU 2 (step SC32). The diagnostic device 300 may display contents of the notification such that the worker can visually recognize those.

The above embodiment represents one specific example to which the present invention is applied but does not limit forms to which the invention is applied.

In the above embodiment, a configuration is made such that the processes illustrated in FIG. 5 to FIG. 7 are executed in a state where no program is written to the memory 93, but the central ECU 2 may overwrite a program to the memory 93, to which a program has been written, in step SA19. In this case, because the program of each of the ECUs 50 of the vehicle control system 1 is newest by the program writing step, work for in advance checking the version of the program can be omitted.

In the above embodiment, a description is made about an example where the memory 220 in a state where that in advance stores the writing data 230 is installed in the vehicle V, but this is one example. For example, after the central ECU 2 is installed in the vehicle V, in the ECU wire-connection step (step S36) or the battery installation step (step S37), or before or after those, the writing data 230 may be transmitted from the diagnostic device 300 to the central ECU 2, and the writing data 230 may thereby be stored in the central ECU 2. In this case, because it is sufficient that data or a program to be stored in the memory 220 by the central ECU 2 is prepared before the program writing preparation step (step S40), a further improvement in efficiency in the manufacturing steps of the vehicle V can be intended.

The action modes of the target ECU 51 which are illustrated in the state transition diagram in FIG. 4 are examples, and each of the ECUs 50 of the vehicle control system 1 may be capable of executing more action modes or may be configured not to include a part of the action modes. It goes without saying that names of the action modes are given for convenience of description and can appropriately be changed.

The configuration of the vehicle control system 1 which is described in the above embodiment is one example, and types of the ECUs 50, the number of ECUs 50, and configurations of devices as control targets of the ECUs 50 included in the vehicle control system 1 can variously be changed. FIG. 1 and FIG. 3 are diagrams illustrating the outline configurations representing principal configurations of the vehicle control system 1 for easy understanding of the invention of the present application but do not limit configurations of devices.

Step units illustrated in FIG. 2 and FIG. 5 to FIG. 10 result from division which corresponds to main process contents for easy understanding of the manufacturing steps of the vehicle V and the actions in the vehicle control system 1 and are not limited by manners of division of the process units or names. Division into more step units may be made in accordance with process contents. Division may be made such that one step unit includes more processes. The order of steps may appropriately be switched. For example, in an action example in FIG. 5, the central ECU 2 transmits the wake-up request in step SA15 and thereafter transmits the first mode transition instruction in step SA17 but may transmit the wake-up request and the first mode transition instruction together. In this case, the corresponding action of the target ECU 51 is a combined process of the step SB11 and step SB13 in FIG. 17.

Contents described in the present embodiment can appropriately be combined. For example, each of a configuration 1 to a configuration 10 which will be described in the following can be combined with the other arbitrary configuration.

The above embodiment supports the following configurations.

(Configuration 1) A vehicle control system including: a vehicle control unit which includes a non-volatile program storage unit and controls a function unit installed in a vehicle by executing a program stored in the program storage unit; and a master control unit which is connected with the vehicle control unit, in which the master control unit includes a non-volatile master storage unit, stores writing data for writing the program to the program storage unit in the master storage unit, transmits a wake-up request to the vehicle control unit, instructs the vehicle control unit which responds to the wake-up request to make transition to a first mode as an action mode for program writing, and executes a writing process of writing the program to the program storage unit provided to the vehicle control unit, on which transition to the first mode occurs, based on the writing data.

In the vehicle control system of the configuration 1, because the program is capable of being written to the vehicle control unit by the master control unit, in manufacturing steps of the vehicle, the master control unit can write the program to the vehicle control unit. Thus, it is possible to supply the vehicle control unit in a state where the program is not installed to the manufacturing steps of the vehicle and to write the program after the vehicle control unit is connected with the master control unit. In a case where the program is written to the vehicle control unit, the master control unit causes the vehicle control unit to make transition to the action mode for the program writing, and writing of the program can thus certainly be completed. Accordingly, while a step of checking a specification or a state of the program of the vehicle control unit and a step of writing the program to each vehicle control unit are skipped or simplified, the program can certainly be managed. Consequently, it is possible to shorten a production time period in a manufacturing factory of the vehicle while an improvement in fuel efficiency of the vehicle and installation of driving assistance technologies and preventive safety technologies in the vehicle are handled, and reduction in an emission amount of carbon dioxide in the manufacturing steps of the vehicle can be realized.

(Configuration 2) The vehicle control system which is described in the configuration 1, in which the writing data include the program which is written to the program storage unit and association data which associate the program with the vehicle control unit, and the master control unit performs the writing process for the vehicle control unit in accordance with the association data.

In the vehicle control system of the configuration 2, the program which is written to the vehicle control unit by the master control unit is clearly specified, and the master control unit can accurately write programs to plural vehicle control units. Thus, a program which is compatible with the vehicle control unit can certainly be written to the vehicle control unit by the master control unit. Accordingly, reliability in the manufacturing steps of the vehicle can more certainly be maintained.

(Configuration 3) The vehicle control system which is described in the configuration 1 or the configuration 2, in which in a case where a state where a signal from the master control unit is not received continues for a predetermined time period in the first mode, the vehicle control unit makes transition from the first mode to a second mode in which control of the function unit is capable of being started.

In the vehicle control system of the configuration 3, in a case where a disturbance occurs to writing of the program, an action state of the vehicle control unit can properly be maintained. For example, in a case where writing of the program is discontinued, a circumstance, in which the vehicle control unit is bound to the first mode and does not respond, or the like can be avoided. Accordingly, handling such as writing of the program to the other vehicle control unit and a retry of writing of the program is possible. Consequently, a time period required for solving a disturbance in the manufacturing steps of the vehicle can be shorten or eliminated, and the production time period in the manufacturing factory of the vehicle can further be shortened.

(Configuration 4) The vehicle control system which is described in the configuration 3, in which in a case where transition occurs from the first mode to the second mode, the vehicle control unit notifies that writing of the program does not succeed to the master control unit.

In the vehicle control system of the configuration 4, because the fact that the vehicle control unit is not in the first mode is notified from the vehicle control unit as a target of the writing process to the master control unit, writing of the program can properly be stopped. Accordingly, handling such as writing of the program to the other vehicle control unit and a retry of writing of the program is possible. Consequently, a time period required for solving a disturbance in the manufacturing steps of the vehicle can be shorten or eliminated, and the production time period in the manufacturing factory of the vehicle can further be shortened.

(Configuration 5) The vehicle control system which is described in any one of the configuration 1 to the configuration 4, including a connection unit that connects an external device which is present on an outside of the vehicle control system with the master control unit, in which in a case where a program writing instruction is input from the external device, the master control unit transmits the wake-up request to the vehicle control unit.

In the vehicle control system of the configuration 5, an instruction is input to the master control unit by the external device, and the master control unit thereby starts writing of the program to the vehicle control unit. Accordingly, a timing of writing of the program by the master control unit can properly be managed. Because it is sufficient that the external device only inputs the instruction to the mater control unit, an advantage is present where a workload in the manufacturing steps of the vehicle is small.

(Configuration 6) The vehicle control system which is described in the configuration 5, in which in a case where a control signal which designates the vehicle control unit and instructs an action of the function unit is input from the external device and a case where the vehicle control unit which is designated by the control signal is executing the first mode, the master control unit notifies that a writing process to the vehicle control unit is executed to the external device.

In the vehicle control system of the configuration 6, the worker who operates the external device can be informed that the writing process of the program is executed. Accordingly, the worker can easily manage a situation of the writing process of the program, and manufacturing efficiency in the manufacturing steps of the vehicle can further be improved.

(Configuration 7) The vehicle control system which is described in the configuration 5 or the configuration 6, in which in a case where a control signal which designates the vehicle control unit and instructs an action of the function unit is input from the external device, the master control unit transmits the control signal to the vehicle control unit, and in a case where the control signal is received from the master control unit in the first mode, the vehicle control unit does not execute control which is instructed by the control signal.

In the vehicle control system of the configuration 7, the vehicle control unit in which the writing process of the program is executed can be prevented from executing an action which influences the writing process. Accordingly, writing of the program to the vehicle control unit can more certainly be executed.

(Configuration 8) The vehicle control system which is described in the configuration 6 or the configuration 7, in which the vehicle control unit is capable of executing plural action modes including the first mode while switching the plural action modes, starts control of the function unit in a case where the control signal is received from the master control unit in a different action mode from the first mode, and does not make transition to the first mode in a case where an instruction to make transition to the first mode is received from the master control unit while control of the function unit is executed.

In the vehicle control system of the configuration 8, in the manufacturing steps of the vehicle, it is possible to cause the vehicle control unit to execute control of the function unit, and the writing process of the program is not executed while the vehicle control unit is executing control of the function unit. Accordingly, in the manufacturing steps of the vehicle, control by the vehicle control unit and the writing process of the program can be prevented from being competitively executed, and control by the vehicle control unit and writing of the program can more certainly be executed.

(Configuration 9) A program writing method in a vehicle control system including a vehicle control unit which controls a function unit installed in a vehicle by executing a program and a master control unit which is connected with the vehicle control unit, the program writing method including: storing writing data for writing the program to the vehicle control unit in a non-volatile master storage unit provided to the master control unit; by the master control unit, transmitting a wake-up request to the vehicle control unit; instructing the vehicle control unit which responds to the wake-up request to make transition to a first mode as an action mode for program writing; and executing a writing process of writing the program to a non-volatile program storage unit provided to the vehicle control unit on which transition to the first mode occurs.

In the program writing method of the configuration 9, because the program is capable of being written to the vehicle control unit by the master control unit, in the manufacturing steps of the vehicle, the master control unit can write the program to the vehicle control unit. Thus, it is possible to supply the vehicle control unit in a state where the program is not installed to the manufacturing steps of the vehicle and to write the program after the vehicle control unit is connected with the master control unit. In a case where the program is written to the vehicle control unit, the master control unit causes the vehicle control unit to make transition to the action mode for the program writing, and writing of the program can thus certainly be completed. Accordingly, while a step of checking a specification or a state of the program of the vehicle control unit and a step of writing the program to each vehicle control unit are skipped or simplified, the program can certainly be managed. Consequently, it is possible to shorten the production time period in the manufacturing factory of the vehicle while an improvement in fuel efficiency of the vehicle and installation of driving assistance technologies and preventive safety technologies in the vehicle are handled, and reduction in the emission amount of carbon dioxide in the manufacturing steps of the vehicle can be realized.

(Configuration 10) A vehicle manufacturing method including: a providing step of providing, in a vehicle, a vehicle control unit which includes a non-volatile program storage unit and controls a function unit installed in the vehicle by executing a program stored in the program storage unit and a master control unit; a wire-connection step of connecting the master control unit with the plural vehicle control units by a communication wire; a writing preparation step of instructing, by the master control unit, the vehicle control unit to make transition to a first mode as an action mode for program writing after the wire-connection step; and a writing step of executing, by the master control unit, a writing process of writing the program to the program storage unit for the vehicle control unit on which transition to the first mode occurs.

In the vehicle manufacturing method of the configuration 10, it is possible to write the program to the vehicle control unit by the master control unit in the manufacturing steps of the vehicle. In a case where the program is written to the vehicle control unit, the master control unit causes the vehicle control unit to make transition to the action mode for the program writing, and writing of the program can thus certainly be completed. Thus, while a step of checking a specification or a state of the program of the vehicle control unit and a step of writing the program to each vehicle control unit are skipped or simplified, the program can certainly be managed. Consequently, it is possible to shorten the production time period in the manufacturing factory of the vehicle while an improvement in fuel efficiency of the vehicle and installation of driving assistance technologies and preventive safety technologies in the vehicle are handled, and reduction in the emission amount of carbon dioxide in the manufacturing steps of the vehicle can be realized.

Reference Signs List
1 vehicle control system
2 central ECU (master control unit)
11 zone-A ECU (vehicle control unit)
13 zone-B ECU (vehicle control unit)
19 DLC (connection unit)
21 processing unit
23 communication device
50 ECU (vehicle control unit)
51 target ECU
91, 91A, 91B, 91C, 91D, 91E, 91F, 91G, 91H processor
93, 93A, 93B, 93C, 93D, 93E, 93F, 93G, 93H memory
(program storage unit)
210 processor
220 memory (master storage unit)
221 control program
222 control data
230 writing data
231 writing processing program
232 writing setting table (association data)
233, 233A, 233B, 233C ECU program
235 result data
300 diagnostic device (external device)
B1 to B14 communication wire
CB communication cable
SS1 initial session (second mode)
SS2 diagnosis session
SS3 programming session
SS4 engineering session
SS5 factory programming session (first mode)
V vehicle

What is claimed is:

1. A vehicle control system comprising:
a vehicle control unit which includes a non-volatile program storage unit and controls a function unit installed in a vehicle by executing a program stored in the program storage unit; and
a master control unit which is connected with the vehicle control unit, wherein
the master control unit
includes a non-volatile master storage unit, stores writing data for writing the program to the program storage unit in the master storage unit,
transmits a wake-up request to the vehicle control unit,
instructs the vehicle control unit which responds to the wake-up request to make transition to a first mode as an action mode for program writing, and
executes a writing process of writing the program to the program storage unit provided to the vehicle control unit, on which transition to the first mode occurs, based on the writing data.

2. The vehicle control system according to claim 1, wherein
the writing data include the program which is written to the program storage unit and association data which associate the program with the vehicle control unit, and
the master control unit performs the writing process for the vehicle control unit in accordance with the association data.

3. The vehicle control system according to claim 1, wherein
in a case where a state where a signal from the master control unit is not received continues for a predetermined time period in the first mode, the vehicle control unit makes transition from the first mode to a second mode in which control of the function unit is capable of being started.

4. The vehicle control system according to claim 3, wherein
in a case where transition occurs from the first mode to the second mode, the vehicle control unit notifies that writing of the program does not succeed to the master control unit.

5. The vehicle control system according to claim 1, comprising
a connection unit that connects an external device which is present on an outside of the vehicle control system with the master control unit, wherein
in a case where a program writing instruction is input from the external device, the master control unit transmits the wake-up request to the vehicle control unit.

6. The vehicle control system according to claim 5, wherein
in a case where a control signal which designates the vehicle control unit and instructs an action of the function unit is input from the external device and a case where the vehicle control unit which is designated by the control signal is executing the first mode, the master control unit notifies that a writing process to the vehicle control unit is executed to the external device.

7. The vehicle control system according to claim 5, wherein
in a case where a control signal which designates the vehicle control unit and instructs an action of the function unit is input from the external device, the master control unit transmits the control signal to the vehicle control unit, and
in a case where the control signal is received from the master control unit in the first mode, the vehicle control unit does not execute control which is instructed by the control signal.

8. The vehicle control system according to claim 6, wherein
the vehicle control unit
is capable of executing plural action modes including the first mode while switching the plural action modes,
starts control of the function unit in a case where the control signal is received from the master control unit in a different action mode from the first mode, and
does not make transition to the first mode in a case where an instruction to make transition to the first mode is received from the master control unit while control of the function unit is executed.

9. A program writing method in a vehicle control system including a vehicle control unit which controls a function unit installed in a vehicle by executing a program and a master control unit which is connected with the vehicle control unit, the program writing method comprising:
storing writing data for writing the program to the vehicle control unit in a non-volatile master storage unit provided to the master control unit;
by the master control unit,
transmitting a wake-up request to the vehicle control unit;
instructing the vehicle control unit which responds to the wake-up request to make transition to a first mode as an action mode for program writing; and
executing a writing process of writing the program to a non-volatile program storage unit provided to the vehicle control unit on which transition to the first mode occurs.

10. A vehicle manufacturing method comprising:
a providing step of providing, in a vehicle, a vehicle control unit which includes a non-volatile program storage unit and controls a function unit installed in the vehicle by executing a program stored in the program storage unit and a master control unit;
a wire-connection step of connecting the master control unit with the plural vehicle control units by a communication wire;
a writing preparation step of instructing, by the master control unit, the vehicle control unit to make transition to a first mode as an action mode for program writing after the wire-connection step; and
a writing step of executing, by the master control unit, a writing process of writing the program to the program storage unit for the vehicle control unit on which transition to the first mode occurs.
